(19) United States
(12) Patent Application Publication
(10) Pub. No.: US 2018/0376051 A9
(43) Pub. Date: Dec. 27, 2018

(54) SURFACE INTEGRATED CAMERA MESH FOR SEMI-AUTOMATED VIDEO CAPTURE

(71) Applicant: Ronald Pride, Dallas, TX (US)

(72) Inventor: Ronald Pride, Dallas, TX (US)

(73) Assignee: Ground Zero at Center Stage LLC, Dallas, TX (US)

(21) Appl. No.: 15/246,814

(22) Filed: Aug. 25, 2016

Related U.S. Application Data
(60) Provisional application No. 62/273,578, filed on Dec. 31, 2015.

(51) Int. Cl. H04N 5/232; H04N 21/4223; H04N 21/2187; H04N 21/218; H04N 21/234; H04N 21/845; H04N 5/247; H04N 21/231

(52) U.S. Cl. CPC H04N 5/23206; H04N 21/4223; H04N 21/2187; H04N 21/231; H04N 21/23424; H04N 21/8456; H04N 5/247; H04N 21/21805

(57) ABSTRACT

An integrated camera mesh is disclosed, wherein the system includes a mesh camera for capturing a video segment, wherein the mesh camera is one of a plurality of mesh cameras. To follow movements of subjects, each mesh camera tilts and swivels autonomously in response to proximity sensor information. The mesh camera is strategically positioned within a flooring inset, which includes a transparent cover, such that the flooring surface remains planner. Video segments from mesh cameras and transmitted to a content server, which processes the received video segments to create a video sequence for transmission to broadcast viewers.

### FIELD

This disclosure relates to capturing digital imagery of a live event and more particularly to a system and method for capturing video content for broadcast, where the content is captured from a subset of surface integrated mesh cameras.

### BACKGROUND

Competition is a core human attribute and the history of sporting events throughout human history has been learned from architectural artifacts such as, the ruins of coliseums in Italy and the ruins ball courts in South America, where the Mesoamerican ballgame, El juego de pelota was played by the Aztecs. These ancient venues were constructed to accommodate large numbers of observers. Significantly, these ruins demonstrate the value that these ancient civilizations placed on providing an up-close experience to attendees, in spite of the large numbers.

Television made sporting events accessible to populations that could not attend live events due to financial or geographic restraints or limited venue occupancy. Moreover, television was able to provide a view that was not even accessible to those with court side seating. While at the mercy of the camera operators, watching a sporting event on a television has several known advantages over live event attendance.

Providers in the entertainment industry have continuously sought ways to distinguish their broadcasts of the broadcasts of competing providers. In pursuit of differentiating attributes, those in the entertainment and broadcasting industries have been fast to adopt new technologies that may further enhance the broadcast viewing experience. More specifically, advancements in digital media and miniaturization has led to the recent sporting event broadcasting enhancements such as Hawk-Eye and Player Cam. Hawk-eye is a complex computer system used in the broadcasts of numerous sporting events to visually track the trajectory of a ball, for example, to display a moving image representing a statistically most likely path of trajectory. Player Cam comprises a small wireless camera that is mounted to a player's helmet, for example, to capture the events of a match or game from the perspective of the wearer.

Camera miniaturization and high-speed wireless networks have made it possible for fans to view their favorite live events from the comforts of their homes. Not having the inconveniences normally associated with attending a live event combined with having a better than front-row view of the event has caused home viewership to become the preferred viewing experience form many. Also, conflicting television schedules no longer require viewers to choose between one broadcast or another, as viewers are able to view multiple sporting events simultaneously due to rapidly declining costs of televisions and having the ability to view digital broadcasts from virtually any personal computing device, such as a smartphone, tablet, or personal computer (PC).

Despite improvements in video quality and availability, a core problem remains that cannot be resolved by way of any presently known technology. Although today's sports broadcasts provide viewers with live images from a variety of camera angles, the viewer remains subject to view an event from the perspective of a camera operator, whether the operator is behind a camera or in a control room. Attempts have been made to provide more control to the viewer in this regard, but to date, many have failed or have not been well received as a result of negatively impacting the viewing experience. Split screens and picture-in-picture, for example, provide the viewer with two or more camera angles, where the viewer chooses to focus in on one of the picture options on a video display. However, these technologies have not achieved widespread acceptance due, at least in part, to distraction resulting from two or more images within a limited display area.

As previously described, new technologies have allowed cameras to be positioned in new and unique locations to view an event from diverse perspectives. However, positioning cameras too close to the action is either not feasible or practical. Therefore, existing video capture and broadcasting systems and methods are limited in that they are not able to provide all viewers with optimal video content, as each viewer has unique preferences and objectives.

To address the above described disadvantages, which are inherent in prior art event video capture methods, there is need for a system and method for capturing video imagery from a plurality of remotely controlled cameras that are positioned within a field of play. Moreover, there is a need for a system that facilitates individual viewer selection of precise camera angles for viewing a live event. Furthermore, there is a need for a system for automating camera angles relative to movements of one or more subjects. In other words, a system is needed that is configured to control the movements of multiple cameras to simultaneously follow movements within a court, field, rink, or stage.

### SUMMARY

In the view of the foregoing disadvantages inherent in sports/event broadcasting, an improved method for capturing digital video content from a plurality of floor integrated cameras (i.e., mesh cameras) is herein disclosed. In various embodiments, the integrated camera mesh system includes a mesh camera for capturing a video segment, wherein the mesh camera is one of a plurality of mesh cameras. A content server is configured to process the video segment to create a video sequence. An access server is configured to transmit the video segment to a content provider, wherein the content provider broadcasts the video segment.

In one embodiment, the mesh camera is positioned within a floor inset and includes a lens that is configured for vertical and horizontal movement. The vertical and horizontal movement is by way of an electric motor that is activated and deactivated by way of a signal from a microcontroller.

In one embodiment, the mesh camera includes an integrated sensor for deriving positional and proximal information relative to a target. The sensor is a proximity sensor that measures distance and proximity using infrared, laser, visible light, and/or sound. In another embodiment, sensor data is received from an external sensor, wherein the sensor data comprises positional and proximal information relative to an event. The external sensor is a proximity sensor that measures distance and position based on infrared, laser, visible light, or sound.

In one embodiment, the content server processes a video segment to modify attributes, store the video segment in a database, and digitally splice the video segment with a prior video segment to create a video sequence. The content server may receive an instruction relating to processing from a director interface by way of a wireless network or a wireline network. The received instruction is processed by a mesh camera microcontroller. The system of claim 4, wherein the instruction activates a mesh camera stepper motor.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

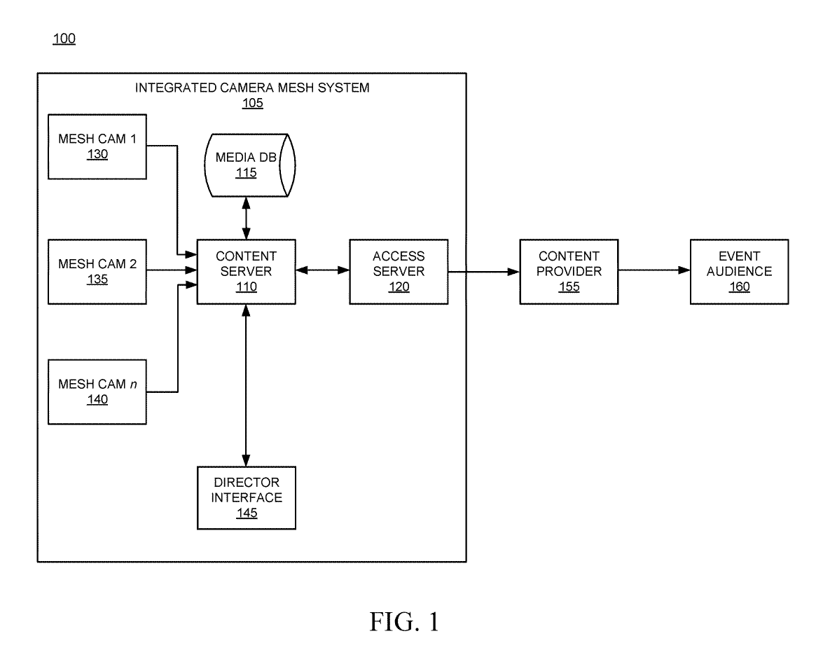

FIG. 1 is a system diagram showing hardware, software, and networking components for an exemplary surface integrated camera mesh, in accordance with various embodiments;

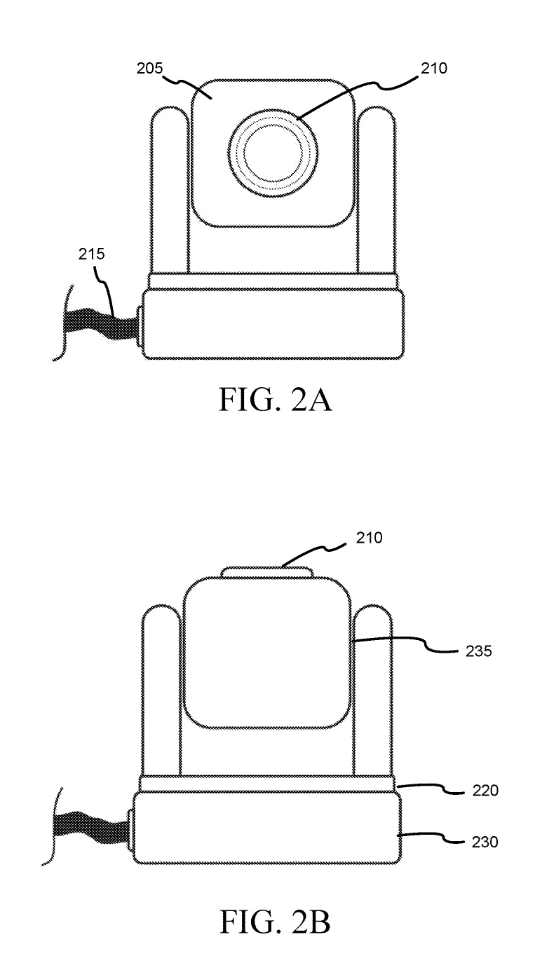

FIG. 2A illustrates a front perspective of a mesh camera having a lens positioned horizontally, in accordance with various embodiments;

FIG. 2B illustrates a front perspective of a mesh camera having a lens positioned vertically, in accordance with various embodiments;

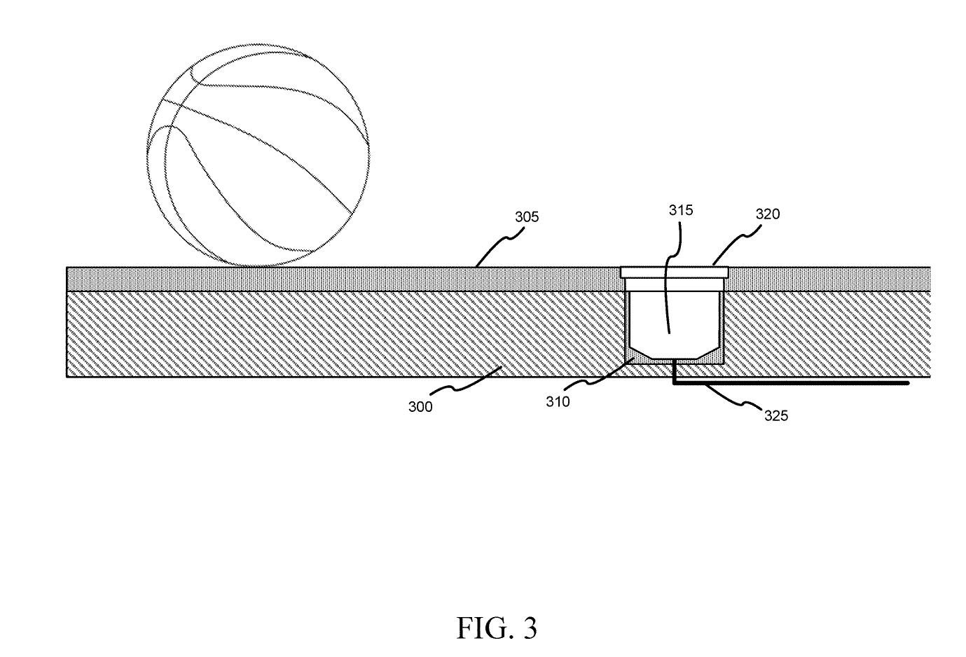

FIG. 3 is a cutaway perspective of a court floor segment having a camera inset for housing a mesh camera, in accordance with the present invention;

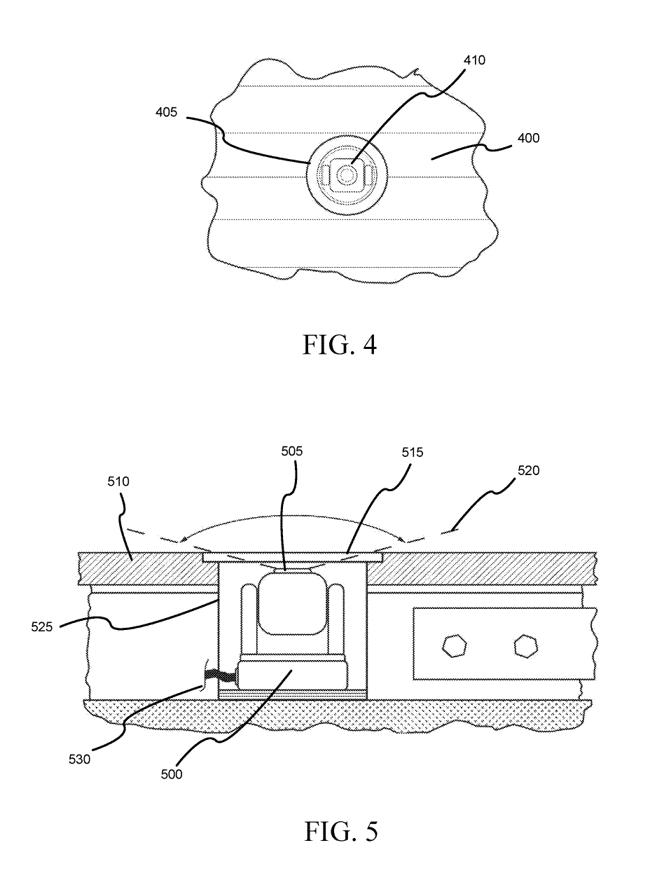

FIG. 4 is a top-down perspective of a court floor area having a surface integrated mesh camera, in accordance with the present invention;

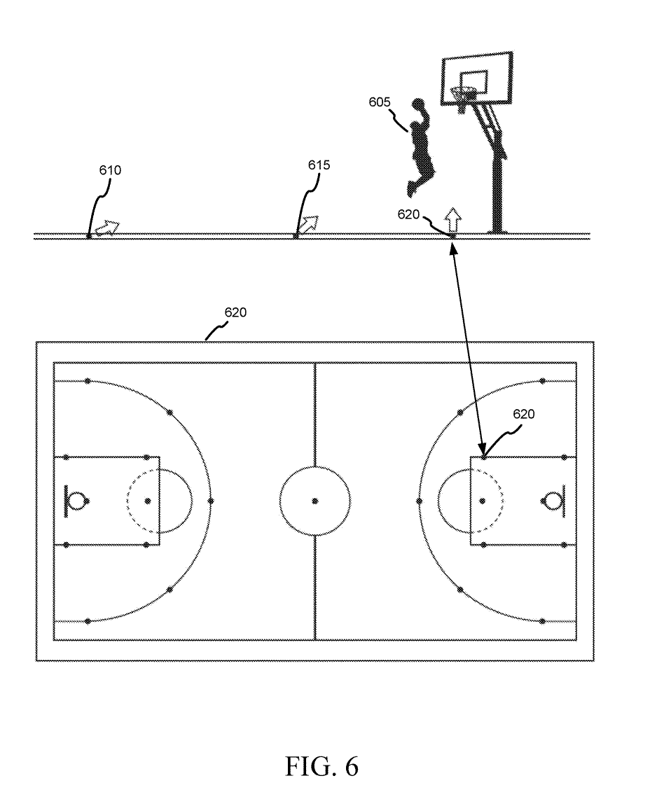

FIG. 5 is close-up cutaway perspective of a court floor segment having a surface integrated mesh camera, in accordance with the present invention; and

FIG. 6 is distal side and top-down perspective of a basketball court showing integrated camera positioning in a mesh configuration, in accordance with the present invention.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Disclosed is a system and method for capturing and sequencing video by way of a surface integrated camera mesh and a uniquely configured content server. In various embodiments, a camera mesh comprises a series of networked high-resolution cameras (i.e., “mesh cameras”). Each mesh camera is disparately imbedded within a floor of a game court, playing field, stage, or similar. More particularly, each mesh camera is imbedded below the floor surface and is shielded at floor-level by a high-strength transparent window, such that the mesh camera is virtually unseen and the floor surface remains unobstructed.

Systems and methods are described relative to the corresponding figures. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

FIG. 1 is a system diagram showing hardware, software, and network components for an exemplary surface integrated camera mesh, in accordance with various embodiments. Various components of the system are described relative to general functionality and not to precise architectural features. For example, a content server 110 is described herein relative to receiving a connection request, verifying credentials, receiving camera feeds, formatting data, storing data, and transmitting data, etc. However, those of ordinary skill in the art will appreciate that each of those features attributed to the content server 110 may be distributed among various interconnected hardware and/or software components. Such interconnected components may include, for example, a relational database management system (RDMS), security server, firewall, HTTP server, and the like.

As used herein, a content server 110 may comprise any hardware, software, networking components, or combination thereof, for receiving digital data from any number of mesh cameras 130, 135, 140 and process the data in virtually real-time to create broadcast quality video output. Specifically, the content server 110 transforms received video segments to create video sequences for distribution, by way of broadcast, to subscribing devices.

In various embodiments, video segments may be selected from a subset of mesh cameras 130, 135, 140 in response to one or more instructions received from a director interface 145. As used herein, a director interface 145 comprises a computer interface for interacting with the content server 110. The director interface 145 may be accessible by way of a commercially available personal computer, tablet computer, smartphone, or by way of a special purpose computing device. In one embodiment, the director interface 145 provides means to control and set video capture values either in real-time or in relation to future events. The director interface 145 may be accessed by way of a direct network connection with the content server 110, a public network (e.g., the Internet), or by any other means known in the art.

In various embodiments, the content server 110 maintains a network connection with a plurality of mesh cameras 130, 135, 140. Content server 110 interfaces mesh cameras 130, 135, 140 in a camera mesh to issue commands and receive image data. In one embodiment, the content server 110 activates, deactivates, rotates, tilts, and focuses individual mesh cameras 130, 135, 140 in response to sensor data, stored parameters, and/or real-time commands received from the director interface 145.

In various embodiments, a database (media DB 115) maintains records relating to video capture parameters as defined by way of the director interface 145 or any other source. In one embodiment, the media DB 115 stores video sequences for subsequent broadcast or for use in officiating a game or match, for example. For example, media DB 115 may store video content received from all cameras within a camera mesh. As such, video may be sequenced and used for a variety of uses outside of the original broadcast. For example, having video segments as captured from all cameras within a camera mesh allows officials to settle a controversial foul call by having an ability to review the play from virtually all camera perspectives.

Selected segments are processed by the content server 110 and compiled one after another (i.e., sequenced), such that two or more video segments form a complete video sequence. For example, a subset of three mesh cameras 130, 135, 140 may each capture a short video segment as a player traverses a basketball court. In response to motion data via a sensor, motors cause each respective mesh camera 130, 135, 140 to track the movement of the player as he/she passes within the viewing area of each. As a segment is received at the content server 110, it is spliced together with other related segments to create a virtually seamless sequence that follows a player as he runs down the court.

The content server 110 formats video content received from the mesh cameras 130, 135, 140 in accordance with preset parameters or real-time commands. The formatted video content may be transmitted over a network to a provider 155 for broadcast to an audience 160 comprising the general public and/or subscribing viewers.

In various embodiments, content distribution is managed by a content server 120. The access server 120 may comprise any hardware and/or software configured to manage access to data created, formatted, and/or stored within the integrated camera mesh system 105. The access server 120 may reside as a standalone hardware system or as a software embodiment within the content server 110. The integrated camera mesh system 105 may include a known and commercially available access server 120 or a proprietary access server 120 that is configured specifically for the functions disclosed herein.

In one embodiment, the access server 120 stands as a security barrier to limit connections with the content server 110. In another embodiment, the access server 120 is a distribution manager that provides video content from the content server 110 to authorized content providers 155. A content provider 155 as used herein, may include a network broadcaster such as, for example, ABC, NBC, and CBS. The content provider 155 may also comprise a subscriber based broadcaster such as, ESPN, Comcast Sportsnet, Eurosport, and the like.

An event audience 160, as used herein, may comprise network television viewers and/or subscribing viewers. In one embodiment, an event audience 160 may receive video content directly from the integrated camera mesh system 105, when the owner/operator of the integrated camera mesh system 105 is also the content provider 155. In another embodiment, the content provider 155 distributes video content as a content reseller or as a contracting entity.

In one embodiment, the event audience 160 receives video content by way of a subscribing device. A subscribing device may include any display equipped device that is configured to receive, format, and present digital data from the content provider 155 or the integrated camera mesh system 105. A subscribing device may receive video content by way of a radio transmission, wireless network, cable, or satellite. For simplicity, the term “subscriber device” is used herein to reference any device that may be used for viewing sequenced video content produced by the integrated camera mesh system 105. A subscriber device may comprise, for example, a smartphone, tablet, laptop computer, personal media device, and television set.

With minimal to no modification to the embodiments disclosed herein, the surface integrated camera mesh may be implemented within any rigid and level surface. Further, having minimal to moderate modification, the disclosed surface integrated camera mesh may be implemented within a soil, gravel, turf, or ice surface. These and other implementations for the surface integrated camera mesh and supporting systems are contemplated.

FIG. 2A illustrates a front perspective of a mesh camera having a lens positioned horizontally, in accordance with various embodiments. In various embodiments, the mesh camera 200 comprise commercially available CMOS cameras, having broadcast quality resolution. While not shown in the figures, the mesh camera 200 is motorized to facilitate dynamic alignment between camera lens 215 and a target (i.e., subject). Lens housing 215 movement and lens 215 zoom features allow for 365-degree imaging of subjects at varying distances.

In various embodiments, a mesh camera 200 is powered by an electrical wire 215 that provides between 5 and 30 volts DC. Most commercially available digital video cameras require between 9 and 12 volts for proper operation. However, those of ordinary skill in the art will appreciate that mesh cameras having any power configuration may be used without departing from the scope of this disclosure. In one embodiment, a mesh camera 200 includes a battery for primary or emergency backup power.

For sending and receiving video and other data, the mesh camera 200 includes at least one means for connecting to a network. As used herein, a network may include any hardware and/or software for facilitating wireline or wireless data transmissions. In one embodiment, the mesh camera 200 sends and receives data by way of a wireless protocol, such as Bluetooth, WiFi, or any other communication protocol having communications and security features aligning with WEP (Wired Equivalent Privacy) or similar standard. WEP is a security protocol, specified in the IEEE Wi-Fi standard, 802.11 and is the generally accepted protocol for commercial wireless networking.

The mesh camera 200 may be housed in a hard plastic or metallic case 205 that provides protection to sensitive camera electronics. In one embodiment, an outer housing 205 for the mesh camera 200 is manufactured from ABS (Acrylonitrile Butadiene Styrene), which provides sufficient protection against impact and chemicals but is less resilient when exposed to sunlight for prolonged periods. In another embodiment, the housing 205 comprises Acrylonitrile Styrene Acrylester and Polycarbonate blend in order to provide durability while also resisting environmental variables. However, those of ordinary skill will appreciate that the housing 205 may comprise any material that suitably provides electronic shielding and impact resistance.

FIG. 2B illustrates a front perspective of mesh camera having a lens positioned vertically, in accordance with various embodiments. To follow movement within a defined proximity, the mesh camera 200 pivots vertically and swivels horizontally in order to align the lens 210 with a target (i.e., subject). The mesh camera may use any mechanism known for moving a camera assembly in a plurality of directions. In accordance with one embodiment, as shown in in FIG. 2B, the camera housing 205 pivots vertically by way of pivoting joint 235 between the housing 205 and frame 220 positioned on each side of the housing 205. The mesh camera 200 further swivels, or rotates horizontally by way of a rotating joint 225, which is positioned between the frame 220 and the base 230.

In various embodiments, directional positioning of the mesh camera 200 in accordance with the above, are managed either autonomously, manually, or a combination of automatic and manual. Mesh camera 200 pivoting or swivel movement is facilitated by way of one or more electric motors, or stepper motors, receiving instructions from an integrated microcontroller. One or more microcontrollers provide camera motion control in response to signals received from one or more sensors and/or a human operator.

In various embodiments, mesh camera 200 movement by way of integrated stepper motor is managed in accordance with one or more sensors. A proximity sensor using infrared light, laser, or sound reflection allows the mesh camera microcontroller to track nearby targets. Such tracking technologies are known in the art and the disclosed integrated camera mesh system may implement any such technology without departing from the scope of the invention. In another embodiment, an external sensor, such as a CMOS, is configured to provide instructions to any number of connected mesh cameras. An external sensor may monitor movements within a defined area and send instructions to each linked mesh camera 200 either individually or in a group. To transform sensor signals to stepper motor movements; calculations may be performed by either the on-board microcontroller or by the content server 110. When executed by the content server 110 based on external sensor data, for example, commands may be transmitted to one or a plurality of mesh cameras 200 to facilitate tracking of one or more targets in real time.

In embodiments where the mesh camera 200 is autonomously controlled, the director interface 145 provides a means, whereby autonomous controls may be overridden with operator commands via director interface 145. The director interface 145 may also allow an operator to issue commands in concert with autonomous mesh camera control. Employing both autonomous and operator control allows the operator, for example, to zoom in on the motion of a ball rather than a more general view of the player that is dribbling the ball, as directed by the camera mesh 200 microcontroller functioning in autonomous mode.

In various embodiments, the mesh camera 200 combines features found in other known cameras. For example, the mesh camera 200 includes features commonly found in professional video cameras that generally offer extremely fine-grained control for the camera operator. In one embodiment, the mesh camera 200 includes three CMOS sensors to separately record red, green and blue. However, as CMOS technology has improved, this is not required as commercially available video cameras at the higher-end are capable of imaging at nearly the same broadcast quality as somewhat older but highly specialized cameras.

While general mesh camera 200 features have been disclosed relative to the integrated camera mesh system, the mesh camera 200 may include a number of additional features and configurations including:
Camera tilt (pivot) angle: −30° to +90° at 60° per second maximum
Camera pan (swivel) angle: −170° to +170° at 60° per second maximum
12-volt power supply
High quality lens, for example: Carl Zeiss Vario-Sonnar TE or equal
I/3 type HD 3-CCO imager. with approximately 1 M pixels
Built in automatic focus 48× zoom (12× optical, 4× digital)
Angle of view: 5.5° at maximum zoom, 60° at minimum zoom
Tide system expandability with interface card slot for optional cards
External synchronized input
16 position presets
RS-232C/RS-422 serial control (VISCA protocol)
Daisy chain capability (up to 7 units)
Image stabilization
NO adaptable filter (changes with incident light levels)

FIG. 3 is a cutaway perspective of a court floor segment having a camera inset for housing a mesh camera, in accordance with the present invention. For explanation, the surface integrated camera mesh system is illustrated and described relative to a basketball court. Those of ordinary skill in the art will recognize many uses beyond those discussed herein and many additional implementations have been contemplated. As such, specific examples and configurations presented herein should be read in broadest terms and not as limitations to the disclosed systems and methods.

In one such implementation, the surface integrated camera mesh may be installed within a basketball court in order to provide highly targeted video capture capability within an active and fast moving environment. A floor may be constructed or modified to integrate mesh cameras. A mesh camera inset 310 is formed such that a mesh camera (plus supporting hardware) sits below a flooring cover 305. To ensure that the mesh camera is shielded from moisture and particulates, which could degrade camera performance and image quality, a canister 315 is positioned within the floor inset 310. The canister 315, being manufactured from a durable plastic or metal, may be permanently secured within the inset 310 by way of an adhesive or removably secured by way of a faster, such as screws. In one embodiment, the canister 315 simply sits within the inset where it is held in place by the floor and walls of the inset 310.

Installing the integrated camera mesh within a pre-constructed concrete floor 300 may require use of a large-diameter drill bit or boring machine to create the inset 310. When modifying an existing flooring area, mesh cameras configured with battery capacity may be an optimal solution to avoid extensive disruption to the foundation 300 and flooring cover 305. To simplify routine maintenance tasks that may be necessary to replace batteries in mesh cameras, the canister 315 may be easily lifted out of the inset 310 by a technician or maintenance worker.

For embodiments relying on an external power supply, the concrete foundation 300 may be scored or cut to allow power supply wiring 325 to be installed, such that a flooring cover 305 (e.g., wood) hides any underlying foundation work. Also, where the mesh cameras are networked via a wireline configuration, a Category 5 (or similar) cable may also need to be installed. In accordance with these embodiments, routine maintenance may be reduced significantly, as the mesh cameras should only need to be accessed in event of camera failure.

To seal and/or protect an underlying mesh camera and to ensure that the flooring surface remains planner, a glass or plastic cover 320 is positioned over the inset 310. In various embodiments, the cover 320 is manufactured from and alkali-aluminosilicate reinforced glass, which is resistant to scratching and breakage. In one embodiment, the cover 320 is held into place by way of a fastener or adhesive. In another embodiment, the cover 320 and the canister 315 have mating threads, such that the cover 320 may be screwed into place over the inset 310 and canister 315.

FIG. 4 is a top-down perspective of a court floor area having a surface integrated mesh camera, in accordance with the present invention. A mesh camera 410 is positioned below a surface plane of a floor 400. In various embodiments, the camera is secured within a canister, which is inserted into the inset. To ensure consistency in the planner surface of the floor 400, a plastic or reinforced cglass panel sits or is secured above the inset.

In various embodiments, the cover 410 comprises reinforced glass and resembles the density of the surrounding floor 400, such that when a ball is dribbled, passed, etc., there will not be a detectable impact on the rebounding direction and/or velocity.

FIG. 5 is close-up cutaway perspective of a court floor segment having a surface integrated mesh camera, in accordance with the present invention. As previously described with reference to the figures, the mesh camera 500 is positioned within an inset, which is formed in a floor 510. The inset includes a plastic or metal canister 525 to provide base and side protection to the mesh camera 500.

The mesh camera 500 is sealed and/or protected from above by way of a floor-level cover 515, which comprises a durable transparent plastic or glass. The transparent cover 515 allows the lens 505 of the mesh camera 500 to have a clear and unobstructed view of the surrounding area above floor level. The canister 525 and cover 515 are sized to allow the mesh camera 500 to pivot and rotate in order to capture video within a parameter 520 of the mesh camera 500 placement. In one embodiment, the mesh camera 500 is configured to pivot, swivel, and zoom in response to instructions from a content server 110, director interface 145, or similar computing system, using a RS-232 interface, for example.

In various embodiment, the mesh camera 500 transmits television compatible signals by way of a cable such as, for example, a fiber optic cable. Accordingly, the fiber optic cable and power supply cable 530 (in non-battery embodiments) traverses below the floor 510 to interconnect multiple mesh cameras and ultimately connect with the content server 110 by way of an access server 120.

FIG. 6 is distal side and top-down perspective of a basketball court showing integrated camera positioning in a mesh configuration, in accordance with the present invention. In various embodiments, individual mesh cameras 610, 615, 620 are distributed at visually strategic locations within an active event area 620. Such strategic locations may include floor positions where an underlying mesh camera has minimal visual obstructions, minimal overlapping with other mesh cameras, high traffic areas, and/or particularly significant areas or areas of interest (e.g., 3-point line, foul line, basket, etc.).

Video segments from each, or subset, of the plurality of mesh cameras 610, 615, 620 may be synchronized and sequenced to show detailed movements of the player 605 (i.e., a drive from the 3-point line to the basket). As stated herein, the described integrated camera mesh with supporting systems may be implemented within any venue where subjects for video imaging are generally active within a definable area. For example, the surface integrated camera mesh may be integrated with the flooring of a theatrical or concert stage.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

Where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (0 unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An integrated camera mesh system comprising:
a mesh camera for capturing a video segment, wherein the mesh camera is one of a plurality of mesh cameras;
a content server configured to process the video segment to create a video sequence; and
an access server configured to transmit the video sequence to a content provider, wherein the content provider broadcasts the video sequence.

2. The system of claim 1, wherein the mesh camera is positioned within a floor inset.

3. The system of claim 1, wherein the processing includes at least one of: modifying attributes, storing the video segment in a database, and digitally splicing the video segment with a prior video segment to create the video sequence.

4. The system of claim 1, wherein the content server receives an instruction from a director interface.

5. The system of claim 4, wherein the instruction is transmitted by way of at least one of: a wireless network and a wireline network.

6. The system of claim 4, wherein the instruction is processed by a mesh camera microcontroller.

7. The system of claim 4, wherein the instruction activates a mesh camera stepper motor.

8. The system of claim 1, wherein the mesh camera includes an integrated sensor for deriving positional and proximal information relative to a target.

9. The system of claim 8, wherein the integrated sensor is a proximity sensor is based on at least one of: infrared, laser, visible light, and sound.

10. The system of claim 1, wherein a lens of the mesh camera is configured for vertical and horizontal movement.

11. The system of claim 10, wherein the vertical and horizontal movement is by way of an electric motor.

12. The system of claim 11, wherein the electric motor is activated and deactivated by way of a signal from a microcontroller.

13. The system of claim 1, further comprising, receiving sensor data from an external sensor, wherein the sensor data comprises positional and proximal information relative to an event.

14. The system of claim 13, wherein the external sensor is a proximity sensor is based on at least one of: infrared, laser, visible light, and sound.
